(19) United States
(12) Patent Application Publication
(10) Pub. No.: US 2016/0132798 A1
(43) Pub. Date: May 12, 2016

(54) SERVICE-LEVEL AGREEMENT ANALYSIS

(71) Applicant: HEWLETT-PACKARD DEVELOPMENT, L.P., Houston, TX (US)

(72) Inventors: Jean-Charles Picard, Mougins (FR); Dominique Pelissier, Mougins (FR); Anas El Ferachi, Vallauris (FR)

(21) Appl. No.: 14/785,430

(22) PCT Filed: Jul. 26, 2013
(86) PCT No.: PCT/US13/52343

§ 371 Date: Oct. 19, 2015

(51) Int. Cl. G06Q 10/06; G06Q 50/18

(52) U.S. Cl. CPC G06Q 10/0635; G06Q 50/18

(57) ABSTRACT

According to an example, service level agreement (SLA) analysis may include receiving selection of a SLA to be analyzed. The SLA may include clauses including attributes. The SLA analysis may further include receiving selection of a grouping option for the SLA clauses, receiving selection of a sub-grouping option for the SLA clauses, and analyzing the attributes of the SLA clauses based on the selected grouping option and the selected sub-grouping option. The SLA analysis may further include receiving selection of a minimum status of the SLA, evaluating the analyzed SLA clauses based on the selected minimum status, and identifying the SLA clauses based on the analysis related to the selected grouping option and the selected sub-grouping option, and based on the evaluation related to the selected minimum status.

### BACKGROUND

A service-level agreement (SLA) is typically a part of a service contract where a service is formally defined. For example, Internet service providers (ISPs) will typically include SLAs within the terms of their contracts with customers to define the level of service being provided. Such SLAs used by ISPs will typically include a technical definition in terms of mean time between failures, mean time to repair, and/or mean time to recovery, and various other measurable details such as data rates, throughput, etc. It can be challenging to analyze such SLAs.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a service level agreement (SLA) analysis apparatus, according to an example of the present disclosure;

FIG. 2 illustrates a user interface display for a groups option specified as category, a sub-groups option specified as status, and a status option specified as exceeded, according to an example of the present disclosure;

FIG. 3 illustrates a user interface display for the groups option specified as status, the sub-groups option specified as domain, and the status option specified as exceeded, according to an example of the present disclosure;

FIG. 4 illustrates a user interface display for the groups option specified as all, the sub-groups option specified as all, and the status option specified as exceeded, according to an example of the present disclosure;

FIG. 5 illustrates a user interface display for the groups option specified as status, the sub-groups option specified as all, and the status option specified as exceeded, according to an example of the present disclosure;

FIG. 6 illustrates domains and categories for a SLA, according to an example of the present disclosure

FIG. 7 illustrates a user interface display for the groups option specified as all, the sub-groups option specified as all, and the status option specified as exceeded, for the SLA of FIG. 6, according to an example of the present disclosure;

FIG. 8 illustrates a user interface display for the groups option specified as domain, the sub--groups option specified as category, and the status option specified as exceeded, for the SLA of FIG. 6, according to an example of the present disclosure;

FIG. 9 illustrates a user interface display for the groups option specified as domain, the sub-groups option specified as category, and the status option specified as low risk, for the SLA of FIG. 6, according to an example of the present disclosure;

FIG. 10 illustrates a user interface display for the groups option specified as domain, the sub-groups option specified as category, and the status option specified as low risk, for the SLA of FIG. 6, according to an example of the present disclosure;

FIG. 11 illustrates a user interface display for the groups option specified as domain, the sub-groups option specified as category, and the status option specified as low risk, for the SLA of FIG. 6, and a plurality of the SLA clauses displayed, according to an example of the present disclosure;

FIG. 12 illustrates a method for SLA analysis, according to an example of the present disclosure; and

FIG. 13 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure, It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Service-level agreements (SLAs) may be analyzed, for example, by using a data table representation with filtering to select desirable information. For example, a filtering term may be used to determine a real-time business impact of a SLA, and another filtering term may be used to determine real-time SLA status. However, such type of analysis can be limited. Another technique of analyzing SLAs may include the use of a graphical tree view to display a SLA, its clauses, and the status of the clauses. However, if many clauses are breached in a SLA, it can be difficult to select the appropriate clause to analyze the breach. Moreover, SLAs typically include multiple clauses that are not distributed with the same weight in domains and categories of a SLA. For example, a SLA may include many domains and categories, but a few clauses for each, or a few domains and categories, with many clauses for each.

According to an example, a SLA analysis apparatus, a method for SLA analysis, and a non-transitory computer readable medium having stored thereon machine readable instructions to provide SLA analysis are disclosed herein. The SLA analysis disclosed herein may provide for the analysis, for example, of the status and business impact related to SLA management in real-time. The status and business impact may be determined, for example, by the Hewlett-Packard (HP) Universal SLA Manager (HP USLAM), The HP USLAM may provide near real time visibility on the status of SLAs, proactive detection of issues that affect SLAs, reporting on SLA achievement, calculation of rebates and penalties in case of SLA violation, and commitments for a SLA. Based on specific grouping and sorting to define dimensions, a user of the SLA analysis apparatus disclosed herein may select, for example, breached clauses, and SLA items and their estimated impact in terms of penalty because contract objectives are not met. The SLA status may represent the compliance status of a SLA as a whole, and may also represent the compliance status of the clauses contained in a SLA. The SLA overall status may be equal to the worst status of the clauses of the SLA. Further, the SLA clauses may include a range of status indicators such as, for example, breached, at risk high, at risk medium, at risk low, on target, and exceeded. If the measured specifications for a SLA clause are greater than the specifics set forth in the SLA clause, the SLA and the SLA clause status may be designated as exceeded. If a SLA clause is compliant and none of the SLA clauses are either breached or at risk of being breached, the SLA may be designated as compliant, and the SLA clause status may be designated as on target. If none of the SLA clauses for a SLA are violated but one or more SLA clauses are in close proximity of being violated, the SLA and the SLA clause status may be designated as at risk low, at risk medium, or at risk high. The designation of at risk low, at risk medium, and at risk high may be based on user specifications for what is considered low, medium, or high risk. If one or more of the SLA clauses for a SLA is violated, the SLA and the SLA clause status may be designated as breached. Based on the foregoing example of SEA clause status, a user may identify SLA clauses that are of relevance to the user.

With respect to the status indicators of breached, at risk high, at risk medium, at risk low, on target, and exceeded for the SLA clauses, sliders and/or menu options may be used to restrict the range, for example, of SLA clauses that are analyzed and/or displayed. Further, sliders and/or menu options may be used to restrict the range, for example, of business impact of SLA clauses that are analyzed and/or displayed.

The SLA analysis apparatus, the method for SLA analysis, and the non-transitory computer readable medium having stored thereon machine readable instructions to provide SLA analysis disclosed herein may be used, for example, for complete SLA analysis by applying grouping, sorting, and/or range limitations to isolate the desired clauses or SLA to work on. The SLA analysis disclosed herein may also allow for the selection of the correct priority to solve problems when working with SLAs. An SLA and its clauses may be readily analyzed, for example, based on status (e.g., breached clauses or contracts) and their financial impacts. A platform, such as, for example, a tablet may be used to provide finger touch capabilities for selection of menu options, and/or business impact of SLA clauses. A group by approach may be leveraged to provide a box of information to distribute SLA information and select relevant SLA clauses. Further, a user may save a preference of an analysis view such that any grouping, sub-grouping, SLA status, and/or impact range options may be saved and retrieved after logout/login to previous presets. For example, any refresh period, minimal status to display, group by, sub-group by, date of the reference period, or none (i.e., last period available) options may be saved and retrieved after logout/login to previous presets.

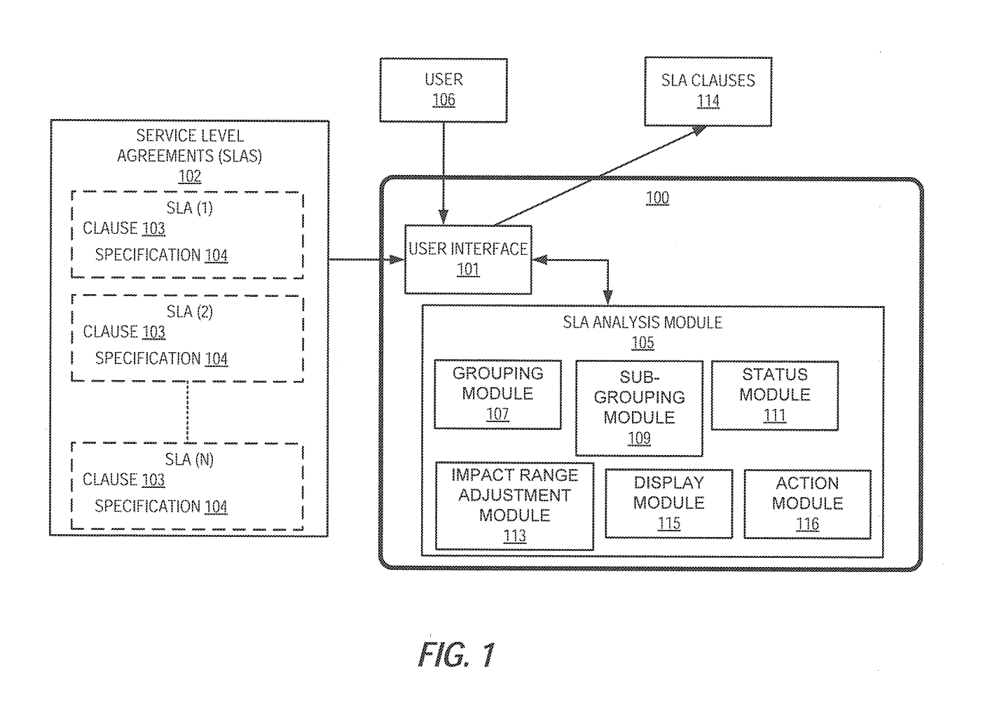

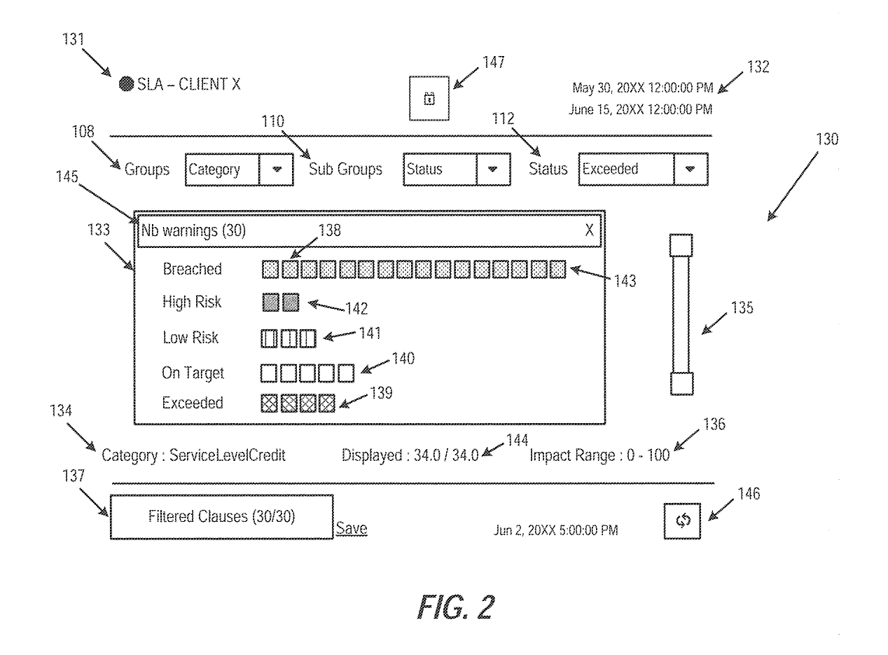

FIG. 1 illustrates an architecture of a service level agreement (SLA) analysis apparatus 100, according to an example. Referring to FIG. 1, the SLA analysis apparatus 100 is depicted as including a user interface 101 to receive a SLA of the SLAs 102 (i.e., SLAs 1-N) for analysis. The SLAs 102 may include SLA clauses 103 that include SLA specifications 104 that may be used to determine attributes of the SLA clauses 103. A SLA analysis module 105 may receive a selection from a user 106 related, for example, to specific SLAs of the SLAs 102 that are to be analyzed. The SLA analysis module 105 may include a grouping module 107 to specify groups 108 (e.g., see FIG. 2) of the selected SLAs that are to be analyzed, and to receive selection of a grouping option for the SLA clauses. The SLA analysis module 105 may further include a sub-grouping module 109 to specify sub-groups 110 (e.g., see FIG. 2) of the groups 108, and to receive selection of a sub-grouping option for the SLA clauses. Further, the SLA analysis module 105 may include a status module 111 to specify minimum status 112 of the SLA, and to receive selection of a minimum status of the SLA. The SLA analysis module 105 may analyze the attributes of the SLA clauses based on the selected grouping option and the selected sub-grouping option, and evaluate the analyzed SLA clauses based on the selected minimum status. An impact range adjustment module 113 may be used by the user 106 to adjust limit or expand) a business impact range of SLA clauses 114 that are output based on the selection of the groups 108 and sub-groups 110, and based on the selection of the minimum status of the SLA. A display module 115 may display identified SLA clauses 114 based on selection of a display option. An action module 116 may initiate a process to execute, for example, a batch action to correct and/or modify any breach or deviation from predetermined specifications, and/or to modify calculations related to the SLA clauses 114.

The modules and other components of the apparatus 100 that perform various other functions in the apparatus 100, may comprise machine readable instructions stored on a non-transitory computer readable medium. In addition, or alternatively, the modules and other components of the apparatus 100 may comprise hardware or a combination of machine readable instructions and hardware.

Referring to FIGS. 1 and 2, FIG. 2 illustrates a user interface display 130 for the groups option (e.g., of the groups 108) specified as category, a sub-groups option (e.g., of the sub-groups 110) specified as status, and a status option (e.g., of the status 112) specified as exceeded, according to an example of the present disclosure, The user interface display 130 may include a SLA title 131 for a SLA selected by the user 106 for analysis. A date range at 132 may represent a reference period in the SLA management. The date range at 132 may be specified as a monthly, weekly, or yearly range, or as another time interval, for example, by selecting the action button 147. The grouping module 107 may be used to specify the groups 108 of clauses for the selected SLA (or SLAs) that is to be analyzed. The grouping module 107 may use, for example, a group by function to group the clauses for the selected SLA (or SLAs). The groups 108 may include options such as, for example, domain, category, status, and all, for selection and grouping of the clauses of the selected SLA. Other options for the groups 108 (as well as the sub-groups 110) may include, for example, customer, supplier, provider, etc., or any other user-defined option, that may be used to isolate the top clauses to work on, and to minimize the business impact at the end of a reference period (e.g., monthly contract, the date range at 132, etc.)

For the domain option, a domain may be defined as an area of a SLA that includes a plurality of categories. For example, a clause may fall in a domain of availability management, where the domain may include a plurality of categories, such as, for example, application uptime, application availability, batch performance, compliance rate, etc. The domain and categories may be user-defined properties of a SLA distribution of the SLA clauses. For example, the domain and categories may be used to organize the SLA clauses for search, retrieval, and analysis.

With respect to the status option, SLA clauses may include a range of status indicators such as, for example, breached, at risk high, at risk medium, at risk low, on target, and exceeded, etc. If the measured specifications for a SLA clause are greater than the specifics set forth in the SLA clause, the SLA and the SLA clause status may be designated as exceeded. If a SLA clause is compliant and none of the SLA clauses are either breached or at risk of being breached, the SLA may be designated as compliant, and the SLA clause status may be designated as on target. If none of the SLA clauses for a SLA are violated but one or more SLA clauses are in close proximity of being violated, the SLA and the SLA clause status may be designated as at risk low, at risk medium, or at risk high. The designation of at risk low, at risk medium, and at risk high may be based on user specifications for what is considered low, medium, or high risk. If one or more of the SLA clauses for a SLA is violated, the SLA and the SLA clause status may be designated as breached.

The all option for the groups 108 may be selected for selecting all options (e.g., breached, at risk high, at risk medium, at risk low, on target, and exceeded, etc.) for analysis. Thus, compared to the domain, category, and status options where the SLA clauses 114 are respectively grouped based on the domain, category, and status criteria, for the “all” option, all options may be grouped in one window.

The sub-grouping module 109 may be used to specify the sub-groups 110 of the groups 108. The sub-grouping module 109 may use, for example, a group by function to group the clauses for the selected SLA (or SLAs) within the groups 108. The sub-groups 110 may include options such as, for example, domain, category, status, and all, for selection and grouping of clauses. Based on the option selected by the user 106 for grouping, the sub-grouping module 109 may allow the user 106 to select from one of the remaining options (except for the case of the “all” option). For example, if the user 106 selects a domain option for grouping, the sub-grouping module 109 may allow the user to select from one of the category, status, and all options.

The status module 111 may be used to specify a minimum status 112 of the SLA that is to be output (e.g., displayed, or otherwise provided to the user 106). For example, SLA clauses may include a range of status indicators such as, for example, breached, at risk high, at risk medium, at risk low, on target, and exceeded, etc. For example, if the user 106 selects at risk medium for the status module 111, the clauses with status greater than or equal to at risk medium may be displayed (e.g., the at risk medium, at risk high, and breached clauses). The remaining clauses (e.g., exceeded, on target, and at risk low) may be hidden. According to another example, the user 106 may select breached for the status module 111 such that the clauses related to exceeded, on target, at risk low, at risk medium, and at risk high are hidden.

The impact range adjustment module 113 may be used to adjust (i.e., limit or expand) a business impact range of SLA clauses 114 that are output based on the selection of the groups 108 and sub-groups 110. For example, referring to FIG. 2, the impact range adjustment module 113 may provide for a slider option at 135 to filter the impact range of the SLA clauses 114 that are output based on the selection of the groups 108 and sub-groups 110. The particular category (e.g., service level credit) of the business impact calculation for the slider option at 135 may be displayed at 134, and may be set in the preferences of the SLA analysis module 105. The impact range may be scaled between 0-100 as shown at 136, or may be scaled at any other user-defined range. For example, the value of zero may represent no impact, and a value of 100 may represent the maximum impact (e.g., monetary value to return to a customer when the SLA is breached) compared to all of the SLA clauses 114. For example, no impact may represent a monetized value of $0.00, and the maximum impact may represent a monetized value of a maximum dollar, or currency amount for all of the SLA clauses 114. Alternatively or additionally, no impact may represent a minimum user-defined value, and the maximum impact may represent a maximum user-defined value for all of the SLA clauses 114. The impact range adjustment module 113 may therefore limit the number of SLA clauses that are analyzed for the specific SLAs of the SLAs 102 that are analyzed. Moreover, the display module 115 may provide a display option at 137 where the user 106 may further display the number of SLA clauses 114.

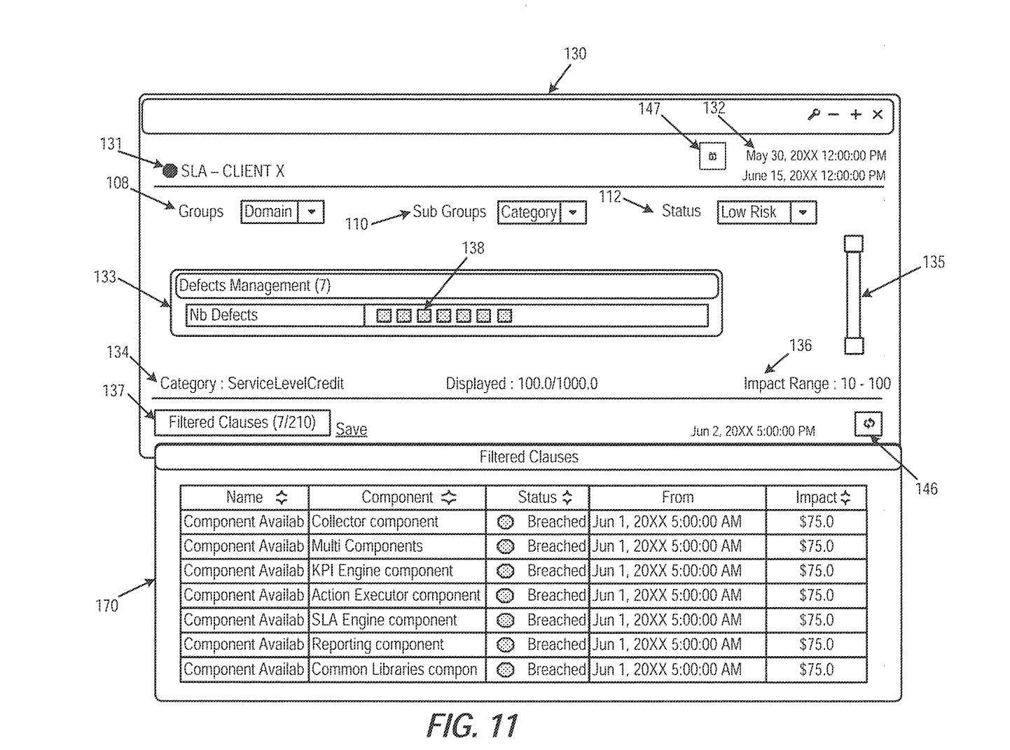

Referring to FIG. 2, based on the selection of the groups 108, the sub-groups 110, the status 112, and the slider option at 135, the SLA clauses 114 may be displayed in the window 133, or otherwise output to the user 106 by using the display option at 137. The window 133 may include the SLA clauses 114 displayed as an icon 138. For the example of FIG. 2 that includes the groups 108 specified as category, the sub-groups 110 specified as status, the status 112 specified as exceeded, and the slider option at 135 selected for a full range of 0-100, the SLA clauses 114 may be displayed using different icons 138 that represent the different statuses of exceeded at 139, on target at 140, at risk low at 141, at risk high at 142, and breached at 143 (note, no SLA clauses 114 are displayed for at risk medium for the example of FIG. 2). The display option at 137 may also be used to display and/or export the SLA clauses 114. For the example of FIG. 2, the display option at 137 shows 30 clauses displayed in the window 133, and may be activated to further display and/or export the SLA clauses 114 as shown in FIG. 11, The display at 144 may represent the total amount of displayed clauses and the total amount of business impact total for the slider option at 135. The number of nb warnings may be displayed at 145. The nb warnings displayed at 145 may represent the group chosen to display, and the number of clauses within each type of group. A refresh button at 146 may be used to manually and/or automatically (e.g., without human intervention) refresh the user interface display 130 after a configurable time duration. A timestamp may also be displayed adjacent the refresh button at 146 to indicate the validity of the displayed data. Further, a reset link button (not shown) may be selected for full reset of criteria (e.g., the groups 108, the sub-groups 110, the status 112, etc.) and scroll range limitations (e.g., for the slider option at 135). The icons 138 may be color coded, include various symbols as shown in FIG. 2, or may be otherwise displayed in a distinguishing manner that represents the respective groups 108 and/or sub-groups 110. For example, with respect to color coding, the icons 138 may be color coded with exceeded shown in blue, on target shown in green, at risk low shown in gold, at risk medium shown in light orange, at risk high shown in dark orange, and breached shown in red, The particular display order of the SLA clauses 114 as shown in the window 133 may be provided in order of breached, at risk high, at risk medium, at risk low, on target, and exceeded, or may otherwise be provided as shown in the window 133 based on a user-defined order.

The action module 116 may initiate a process to execute, for example, a batch action to correct and/or modify any breach, or deviation from predetermined specifications, and/or to modify calculations related to the SLA clauses 114. For example, the user 106 may select clauses from the SLA clauses 114 to correct any breach, or deviation from predetermined specifications. The correction may include, for example, modification of procedures that may impact the select clauses. Further, modification of calculations related to the SLA clauses 114 may include, for example, adding an exclusion period (e.g., based on the date range at 132) to re-calculate status, injection of new raw data or correction of existing raw data for the select clauses, and modification of any other aspects that may affect current calculations on status and business impact.

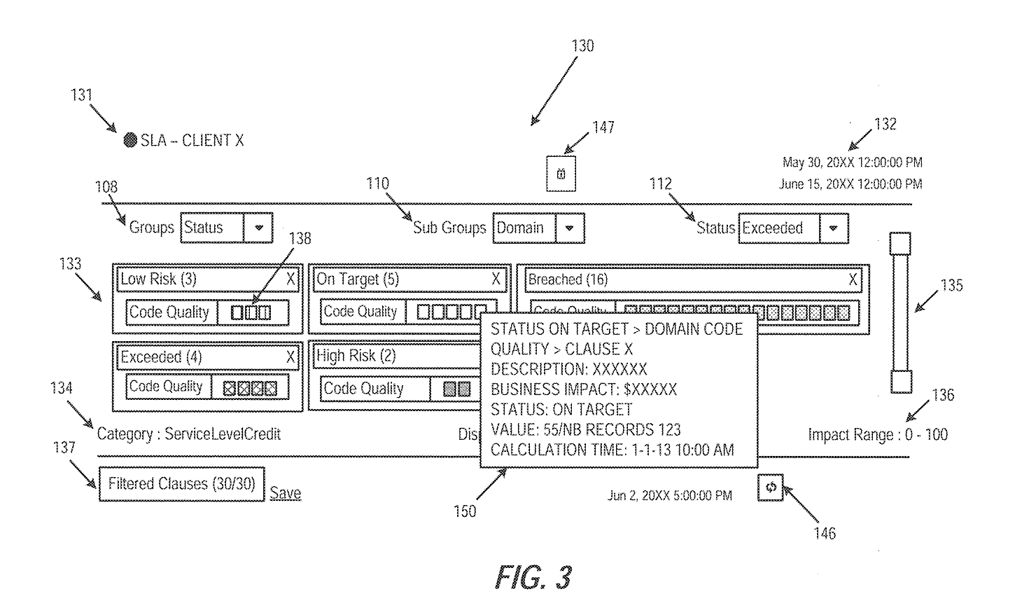

FIG. 3 illustrates a user interface display for the groups 108 specified as status, the sub-groups specified as domain, and the status 112 specified as exceeded, according to an example of the present disclosure. Compared to FIG. 2 which shows the window 133 for the groups 108 specified as category, the sub-groups specified as status, and the status 112 specified as exceeded, it can be seen that FIG. 3 shows a plurality of the windows 133 with the groups 108 specified as status including breached, at risk high, at risk low, on target, and exceeded, and the domain 110 specified as code quality. The icons 138 may be similarly used to display the various SLA clauses 114.

A tooltip 150 may be used by the user 106 to display detailed information on each icon. For example, as shown in FIG. 3, the tooltip 150 shows detailed information for an icon of the groups 108 option of on target, a sub-groups 110 option of domain (e.g., code quality), and a status 112 option of exceeded. Generally, the tooltip 150 may include information such as, for example, clause, name, objective defined, current value, last calculation time, etc. Each window 133 may also include a “X” to allow the user 106 to hide a specific window and to therefore obtain additional space for display of other information. A paginator (e.g., first, previous, nb pages, next, last, etc.) may be provided to allow navigation in the event multiple window pages are needed to display all the information related to the SLAs 114. Alternatively or additionally, the user 106 may scroll through multiple window pages to review all the information related to the SLAs 114.

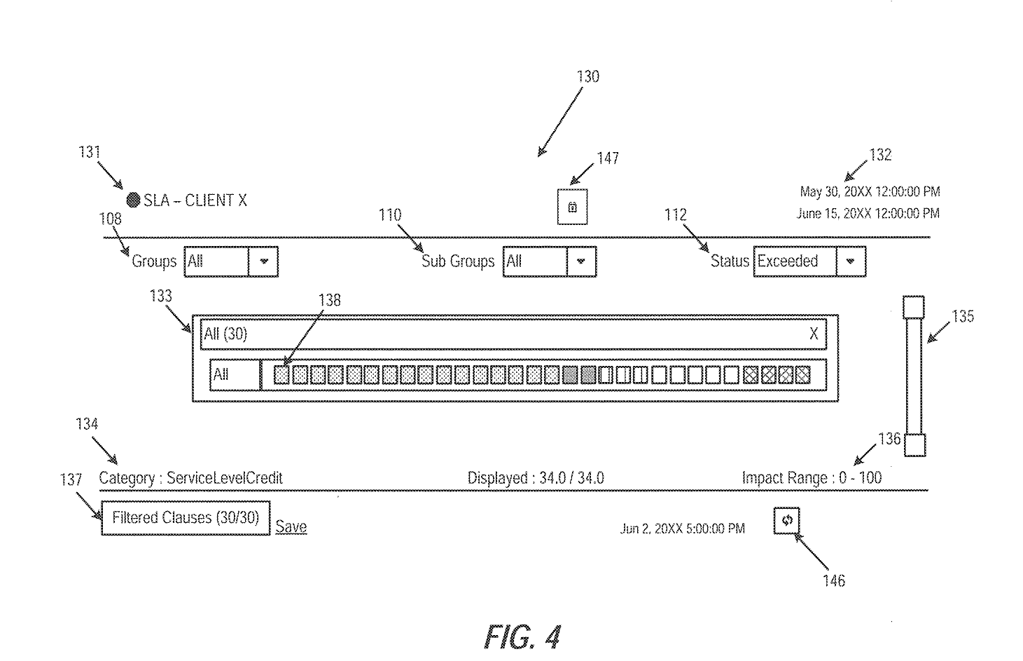

FIG. 4 illustrates a user interface display for the groups 108 specified as all, the sub-groups 110 specified as all, and the status 112 specified as exceeded, according to an example of the present disclosure. Compared to FIG. 3, it can be seen that the selection of the “all” option for the groups 108 and the “all” option for the sub-groups 110 results in a single window 133 with all of the SLA clauses 114 displayed for the selected SLA.

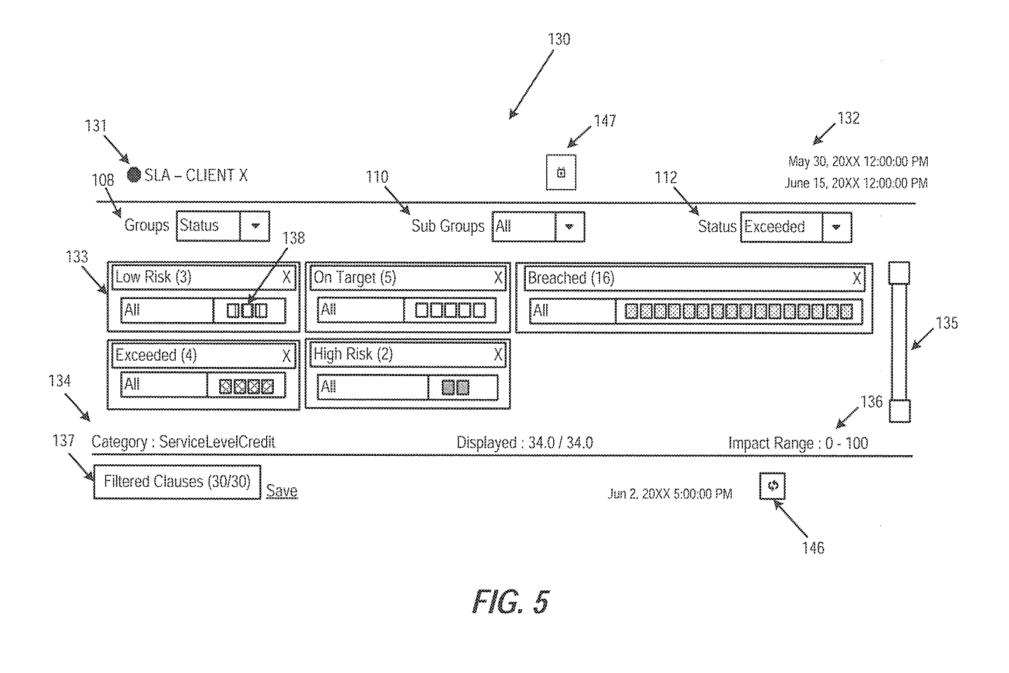

FIG. 5 illustrates a user interface display for the groups 108 specified as status, the sub-groups 110 specified as all, and the status specified as exceeded, according to an example of the present disclosure. Compared to FIG. 4, it can be seen that the selection of the status option for the groups 108 and the “all” option for the sub-groups 110 results in a display similar to FIG. 3, except with the windows 133 being identified by the status of breached, at risk high, at risk low, on target, and exceeded.

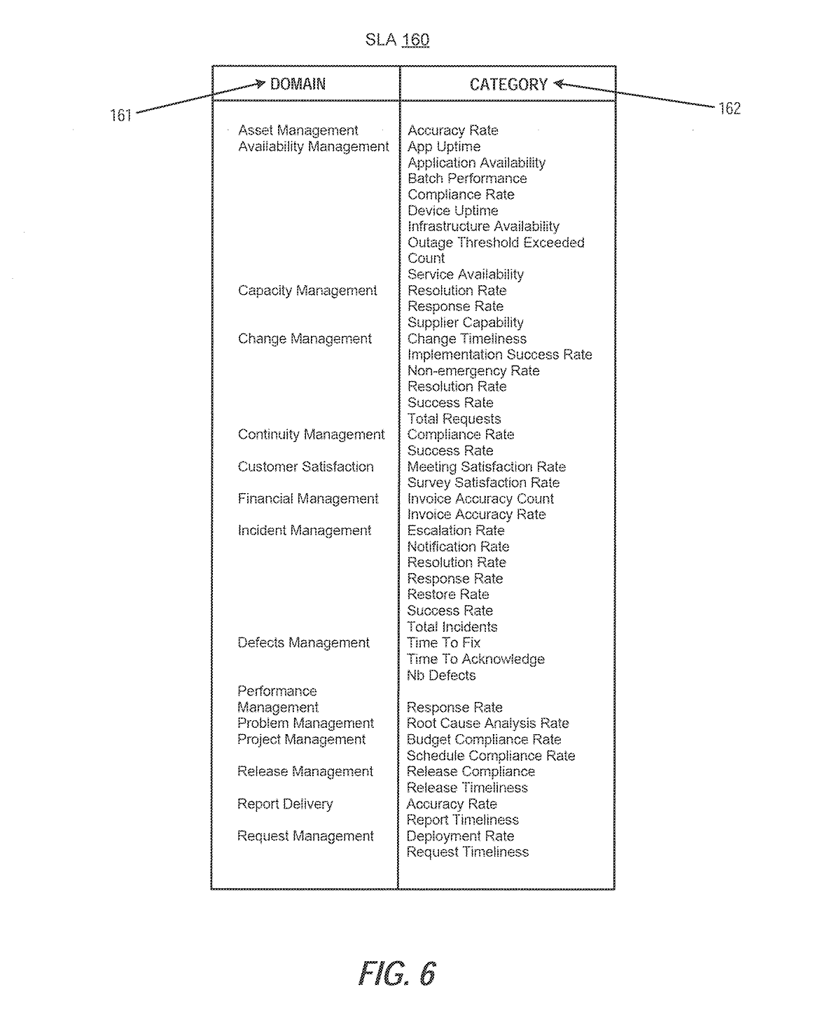

FIG. 6 illustrates domains and categories for a SLA 160 selected by the user 106 for analysis by the SLA analysis apparatus 100, according to an example of the present disclosure. For the example of FIG. 6, the SLA 160 may include domains 161 and categories 162. The example of FIG. 6 represents a partial list of the domains 161 and categories 162 for the SLA 160.

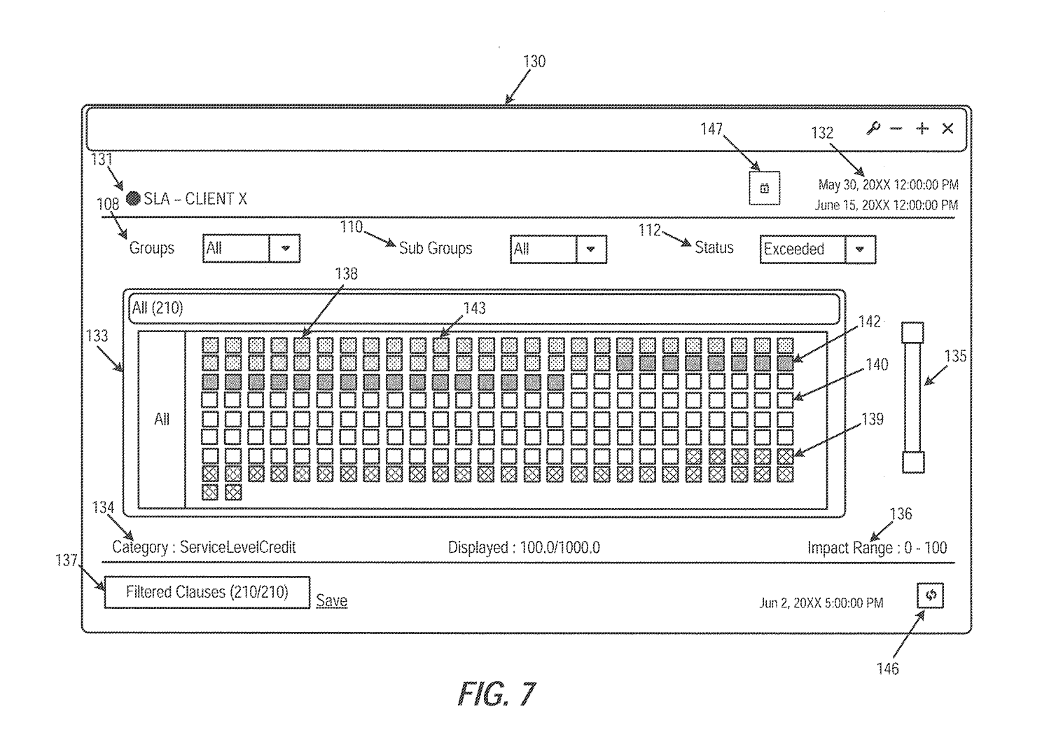

FIG. 7 illustrates a user interface display for the groups 108 specified as all, the sub-groups 110 specified as all, and the status 112 specified as exceeded, for the SLA 160 of FIG. 6, according to an example of the present disclosure. For the SLA 160, based on the selection of the groups 108, the sub-groups 110, and the status 112, the display option at 137 shows 210 clauses displayed in the window 133. The icons 138 of the window 133 may include the status of exceeded at 139, on target at 140, at risk high at 142, and breached at 143 (note, no SLA clauses 114 are displayed for at risk low, and at risk medium for the example of FIG. 7).

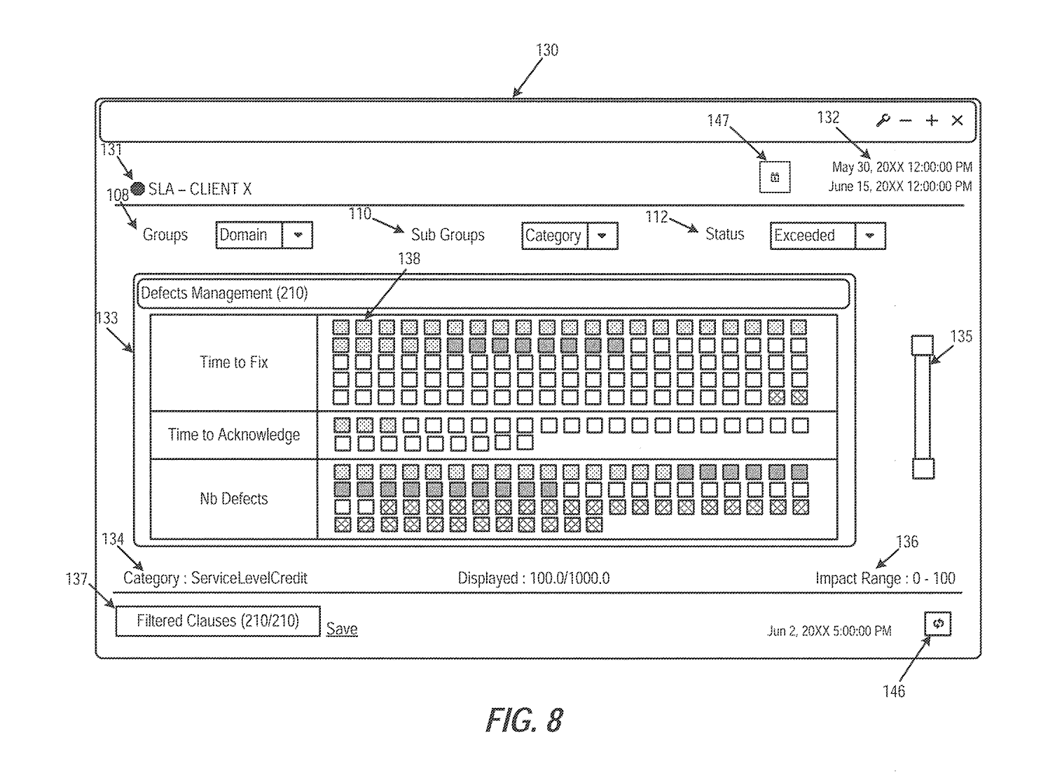

FIG. 8 illustrates a user interface display for the groups 108 specified as domain, the sub-groups 110 specified as category, and the status 112 specified as exceeded, for the SLA 160 of FIG. 6, according to an example of the present disclosure. For the SLA 160, based on the selection of the groups 108, the sub-groups 110, and the status 112, the display option at 137 shows 210 clauses displayed in the window 133. The icons 138 of the windows 133 may include the domain of “defects management” (for example, under the “incident management” domain of FIG. 6), with the categories of “time to fix”, “time to acknowledge”, and “nb defects”.

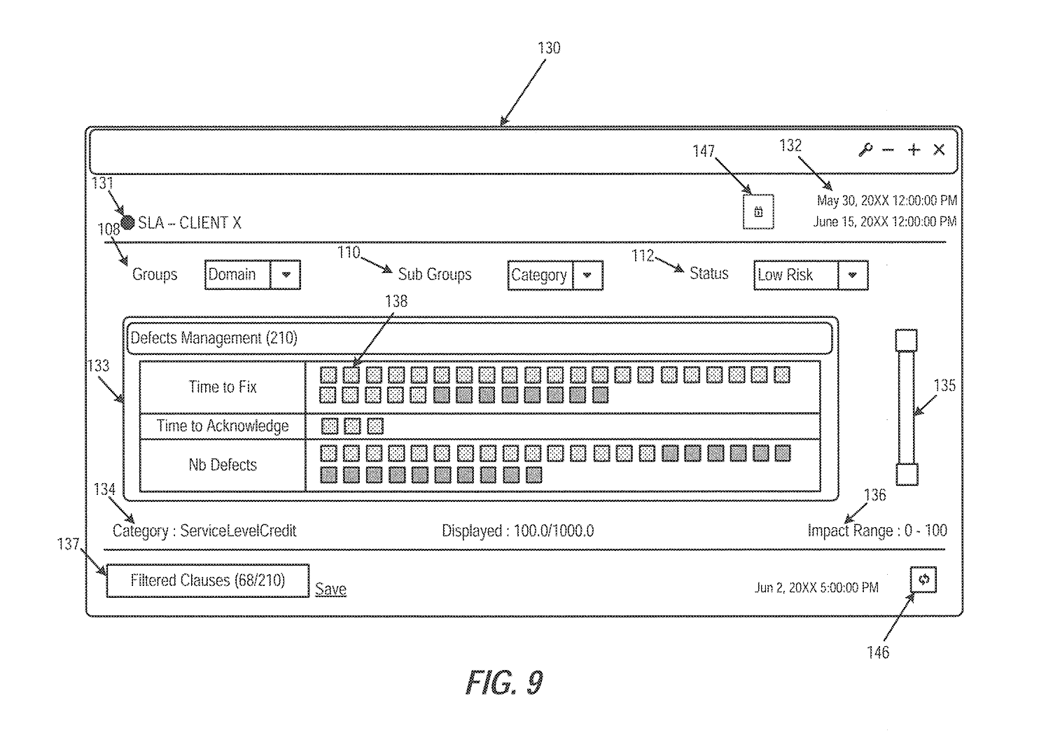

FIG. 9 illustrates a user interface display for the groups 108 specified as domain, the sub-groups 110 specified as category, and the status 112 specified as low risk, for the SLA 160 of FIG. 6, according to an example of the present disclosure. For the SLA 160, based on the selection of the groups 108, the sub-groups 110, and the status 112, the display option at 137 shows 68 out of 210 clauses displayed in the window 133. The icons 138 of the windows 133 may include the domain of “defects management”, with the categories of “time to fix”, “time to acknowledge”, and “nb defects”.

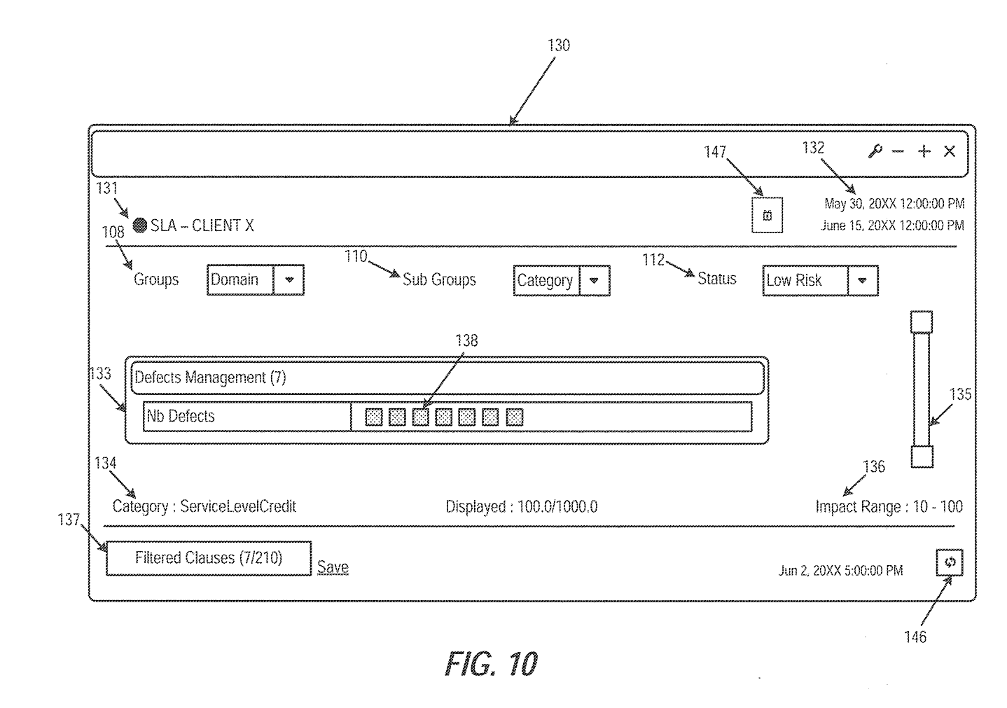

FIG. 10 illustrates a user interface display for the groups 108 specified as domain, the subgroups 110 specified as category, and the status 112 specified as low risk, for the SLA 160 of FIG. 6, according to an example of the present disclosure. For the SLA 160, based on the selection of the groups 108, the sub-groups 110, the status 112, and an impact range using the slider option at 135 of 10-100 (compared to an impact range of 0-100 of FIG. 9), the display option at 137 shows 7 out of 210 clauses displayed in the window 133. The icon 138 of the window 133 may include the domain of “defects management”, with the category of “nb defects” (i.e., where the “nb defects” fall within the impact range of 10-100).

FIG. 11 illustrates a user interface display for the groups 108 specified as domain, the sub-groups 110 specified as category, and the status 112 specified as low risk, for the SLA 160 of FIG. 6, according to an example of the present disclosure. FIG. 11 is generally identical to FIG. 10, but shows the SLA clauses 114 displayed at 170 based on a user selection of the display option at 137.

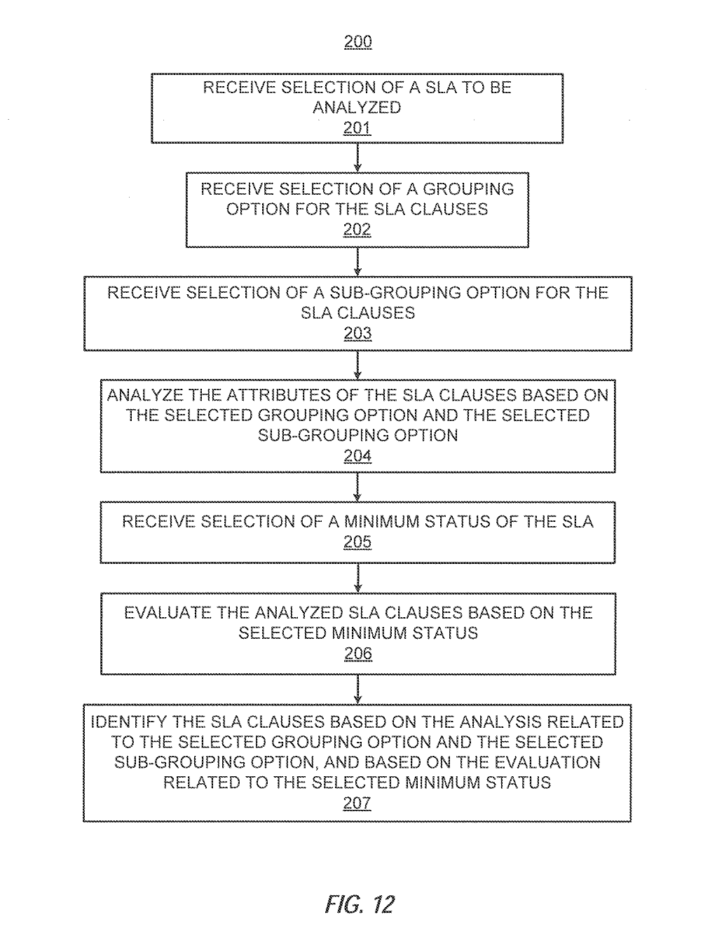

FIG. 12 illustrates a flowchart of a method 200 for SLA analysis, corresponding to the SLA analysis apparatus 100 whose construction is described in detail above. The method 200 may be implemented on the SLA analysis apparatus 100 with reference to FIGS. 1-11 by way of example and not limitation. The method 200 may be practiced in other apparatus.

Referring to FIG. 12, for the method 200, at block 201 selection of a SLA to be analyzed may be received. For example, referring to FIG. 1, a user interface 101 may receive a SLA of the SLAs 102 (i.e., SLAs 1-N) for analysis.

At block 202, selection of a grouping option for the SLA clauses may be received. For example, referring to FIG. 1, the grouping module 107 may be used to specify groups 108 of the selected SLAs that are to be analyzed, and may receive selection of a grouping option for the SLA clauses.

At block 203, selection of a sub-grouping option for the SLA clauses may be received. For example, referring to FIG. 1, the sub-grouping module 109 may be used to specify sub-groups 110 of the groups 108, and may receive selection of a sub-grouping option for the SLA clauses.

At block 204, the attributes of the SLA clauses may be analyzed based on the selected grouping option and the selected sub-grouping option. For example, referring to FIG. 1, the SLA analysis module 105 may analyze attributes of the SLA clauses based on the selected grouping option and the selected sub-grouping option.

At block 205, selection of a minimum status of the SLA may be received. For example, referring to FIG. 1, the status module 111 may be used to specify a minimum status 112 of the SLA, and may receive selection of a minimum status of the SLA.

At block 206, the analyzed SLA clauses may be evaluated based on the selected minimum status. For example, referring to FIG. 1, the SLA analysis module 105 may evaluate the analyzed SLA clauses based on the selected minimum status.

At block 207, the SLA clauses based may be identified on the analysis related to the selected grouping option and the selected sub-grouping option, and based on the evaluation related to the selected minimum status. For example, referring to FIG. 1, the SLA analysis module 105 may identify SLA clauses based on the analysis related to the selected grouping option and the selected sub-grouping option, and based on the evaluation related to the selected minimum status.

According to a further example, the method for SLA analysis may include receiving selection of an impact range of the identified SLA clauses, determining which of the identified SLA clauses fall within the impact range, and identifying the SLA clauses based on the analysis related to the selected grouping option and the selected sub-grouping option, based on the evaluation related to the selected minimum status, and based on the determination related to the impact range.

According to a further example, the method for SLA analysis may include receiving selection of a display option for the identified SLA clauses, and displaying the identified SLA clauses based on the selection of the display option.

According to a further example, for the method for SLA analysis disclosed herein, receiving the selection of the grouping option for the SLA clauses, and receiving the selection of the sub-grouping option for the SLA clauses may further include receiving the selection of the grouping option for the SLA clauses from grouping options including SLA clause domain, SLA clause category of the SLA clause domain. SLA clause statuses, and all SLA clauses, receiving the selection of the sub-grouping option for the SLA clauses from sub-grouping options including the SLA clause domain, the SLA clause category of the SLA clause domain, the SLA clause statuses, and all SLA clauses, and if the selection of the grouping option for the SLA clauses includes one of the SLA clause domain, the SLA clause category of the SLA clause domain, and the SLA clause statuses, limiting the selection of the sub-grouping option to another one of the SLA clause domain, the SLA clause category of the SLA clause domain, the SLA clause statuses, and all SLA clauses.

According to a further example, the method for SLA analysis may include receiving a selection to execute a batch action, executing the batch action to correct a breach of at least one of the identified SLA clauses, and identifying the SLA clauses based on the analysis related to the selected grouping option and the selected sub-grouping option, based on the evaluation related to the selected minimum status, and based on the executed batch action.

According to a further example, the method for SLA analysis may include receiving a selection to execute a batch action, executing the batch action to modify the analysis related to at least one of the identified SLA clauses, and identifying the SLA clauses based on the analysis related to the selected grouping option and the selected sub-grouping option, based on the evaluation related to the selected minimum status, and based on the executed batch action.

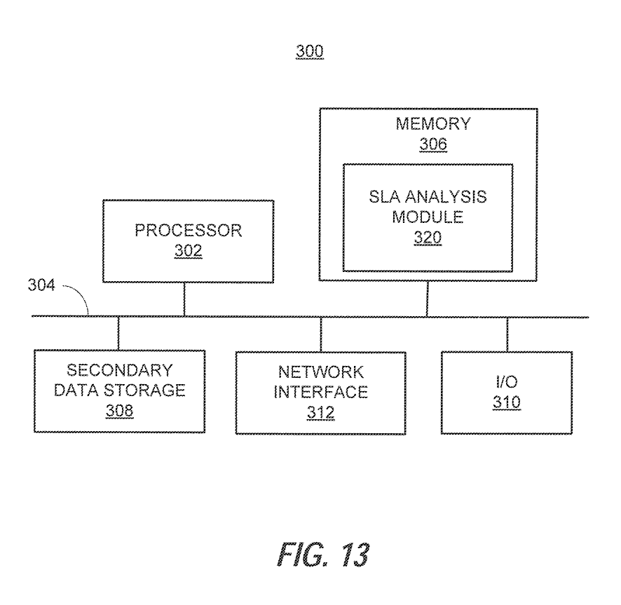

FIG. 13 shows a computer system 300 that may be used with the examples described herein. The computer system may represent a generic platform that includes components that may be in a server or another computer system. The computer system 300 may be used as a platform for the apparatus 100. The computer system 300 may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 300 may include a processor 302 that may implement or execute machine readable instructions performing some or all of the methods, functions and other processes described herein, Commands and data from the processor 302 are communicated over a communication bus 304. The computer system also includes a main memory 306, such as a random access memory (RAM), where the machine readable instructions and data for the processor 302 may reside during runtime, and a secondary data storage 308, which may be non-volatile and stores machine readable instructions and data. The memory and data storage are examples of computer readable mediums. The memory 306 may include a SLA analysis module 320 including machine readable instructions residing in the memory 306 during runtime and executed by the processor 302. The SLA analysis module 320 may include the modules of the apparatus shown in FIG. 1.

The computer system 300 may include an 110 device 310, such as a keyboard, a mouse, a display, etc. The computer system may include a network interface 312 for connecting to a network. Other known electronic components may be added or substituted in the computer system,

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for service level agreement (SLA) analysis, the method comprising:
receiving selection of a SLA to he analyzed, wherein the SLA includes clauses including attributes;
receiving selection of a grouping option for the SLA clauses;
receiving selection of a sub-grouping option for the SLA clauses;
analyzing, by a processor, the attributes of the SLA clauses based on the selected grouping option and the selected sub-grouping option;
receiving selection of a minimum status of the SLA;
evaluating the analyzed SLA clauses based on the selected minimum status; and
identifying the SLA clauses based on the analysis related to the selected grouping option and the selected sub-grouping option, and based on the evaluation related to the selected minimum status.

2. The method of claim 1, further comprising:
receiving selection of an impact range of the identified SLA clauses;
determining which of the identified SLA clauses fall within the impact range; and
identifying the SLA clauses based on the analysis related to the selected grouping option and the selected sub-grouping option, based on the evaluation related to the selected minimum status, and based on the determination related to the impact range.

3. The method of claim 1, further comprising:
receiving selection of a display option for the identified SLA clauses; and
displaying the identified SLA clauses based on the selection of the display option.

4. The method of claim 1, wherein receiving the selection of the grouping option for the SLA clauses further comprises:
receiving the selection of the grouping option for the SLA clauses from grouping options including SLA clause domain, SLA clause category of the SLA clause domain, SLA clause statuses, and all SLA clauses.

5. The method of claim 4, wherein the SLA clause statuses include breached, at risk high, at risk medium, at risk low, on target, and exceeded.

6. The method of claim 1, wherein receiving the selection of the sub-grouping option for the SLA clauses further comprises:
receiving the selection of the sub-grouping option for the SLA clauses from sub-grouping options including SLA clause domain, SLA clause category of the SLA clause domain, SLA clause statuses, and all SLA clauses.

7. The method of claim 6, wherein the SLA clause statuses include breached, at risk high, at risk medium, at risk low, on target, and exceeded.

8. The method of claim 1, wherein receiving the selection of the grouping option for the SLA clauses, and receiving the selection of the sub-grouping option for the SLA clauses, further comprises:
receiving the selection of the grouping option for the SLA clauses from grouping options including SLA clause domain, SLA clause category of the SLA clause domain, SLA clause statuses, and all SLA clauses;
receiving the selection of the sub-grouping option for the SLA clauses from sub-grouping options including the SLA clause domain, the SLA clause category of the SLA clause domain, the SLA clause statuses, and all SLA clauses; and
if the selection of the grouping option for the SLA clauses includes one of the SLA clause domain, the SLA clause category of the SLA clause domain, and the SLA clause statuses, limiting the selection of the sub-grouping option to another one of the SLA clause domain, the SLA clause category of the SLA clause domain, the SLA clause statuses, and all SLA clauses.

9. The method of claim 1, further comprising:
displaying the identified SLA clauses by using icons that represent statuses of the identified SLA clauses.

10. The method of claim 9, further comprising:
differentiating the icons based on at least one of color and symbols.

11. The method of claim 1, further comprising:
receiving a selection to display limited details related to the identified SLA clauses; and
displaying the limited details related to the identified SLA clauses.

12. The method of claim 1, further comprising:
receiving a selection to execute a batch action;
executing the batch action to correct a breach of at least one of the identified SLA clauses; and
identifying the SLA clauses based on the analysis related to the selected grouping option and the selected sub-grouping option, based on the evaluation related to the selected minimum status, and based on the executed batch action.

13. The method of claim 1, further comprising:
receiving a selection to execute a batch action;
executing the batch action to modify the analysis related to at least one of the identified SLA clauses; and
identifying the SLA clauses based on the analysis related to the selected grouping option and the selected sub-grouping option, based on the evaluation related to the selected minimum status, and based on the executed batch action.

14. A service level agreement (SLA) analysis apparatus comprising:
a memory storing machine readable instructions to:
receive selection of a grouping option for the SLA clauses;
receive selection of a sub-grouping option for the SLA clauses;
analyze the attributes of the SLA clauses based on the selected grouping option and the selected sub-grouping option;
receive selection of a minimum status of the SLA;
evaluate the analyzed SLA clauses based on the selected minimum status;
receive selection of an impact range of the identified SLA clauses;
determine which of the identified SLA clauses fall within the impact range; and
identify the SLA clauses based on the analysis related to the selected grouping option and the selected sub-grouping option, based on the evaluation related to the selected minimum status, and based on the determination related to the impact range; and
a processor to implement the machine readable instructions.

15. A non-transitory computer readable medium having stored thereon machine readable instructions to provide service level agreement (SLA) analysis, the machine readable instructions, when executed, cause a computer system to:
receive selection of a SLA to be analyzed, wherein the SLA includes clauses including attributes;
receive selection of a grouping option for the SLA clauses;
receive selection of a sub-grouping option for the SLA clauses;
analyze, by a processor, the attributes of the SLA clauses based on the selected grouping option and the selected sub-grouping option;
receive selection of a minimum status of the SLA;
evaluate the analyzed SLA clauses based on the selected minimum status;
identify the SLA clauses based on the analysis related to the selected grouping option and the selected sub-grouping option, and based on the evaluation related to the selected minimum status;
receive selection of a display option for the identified SLA clauses; and
display the identified SLA clauses based on the selection of the display option.
